(19) United States
(12) Patent Application Publication
(10) Pub. No.: US 2004/0136008 A1
(43) Pub. Date: Jul. 15, 2004

(54) Optical characteristic measurement device and optical type displacement meter

(75) Inventors: Takashi Iwanami, Nagano (JP); Eigi Yanagihara, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/690,965

(22) Filed: Oct. 29, 2003

(30) Foreign Application Priority Data
Oct. 31, 2002 (JP) 2002-317055

(51) Int. Cl. G01B 9/02

(52) U.S. Cl. 356/498

(57) ABSTRACT

An optical characteristic measurement device includes an optical path separation element to which a parallel laser beam is made incident through an aperture, a first face-type photo-detector that receives the laser beam transmitted through the optical path separation element and a second face-type photo-detector that receives the laser beam reflected by the optical path separation element. A length of an optical path from the aperture to the first face-type photo-detector is set to be different from a length of an optical path from the aperture to the second face-type photo-detector. An incident angle of the laser beam and a position of a center of gravity of a distribution of a light quantity of the laser beam at the aperture are measured based on a distance from a reference position to a light receiving center position on the first face-type photo-detector, a distance from a reference position to a light receiving center position on the second face-type photo-detector, the length of the optical path from the aperture to the first face-type photo-detector, and the length of the optical path from the aperture to the second face-type photo-detector.

### BACKGROUND OF THE INVENTION

1. Field of the Invention

The present invention relates to an optical characteristic measurement device for measuring optical characteristics of an incident laser beam and also relates to an optical type displacement meter to which the principles of measuring the optical characteristics of the incident laser are applied.

2. Description of the Related Art

In an optical pickup device used to record or reproduce information onto or from an optical recording medium, an emitted beam from a semiconductor laser emitting element such as a photodiode is converged on an optical recording medium through a light converging optical system. For this purpose, it is regarded to be preferable to use a smaller spot diameter beam converged on the optical recording medium. Although various technical elements are related to obtain the smaller spot diameter, particularly in a converging optical system, optimization of the optical axis, parallelism, and intensity distribution of an incident light beam into a converging lens is required. Therefore, various optical characteristic measurement devices have been proposed to evaluate the optical characteristics of the laser beam.

Conventional optical characteristic measurement devices are shown in FIG. 17 through FIG. 20. The optical characteristic measurement device shown in FIG. 17 includes a collimator lens 102 for forming the divergent light beam emitted from a semiconductor laser beam emitting element 101 into a parallel beam, a laser autocollimator 110 for detecting the light beam emitted from the collimator lens 102, and a display device 111. According to this measurement device, the optical axis and parallelism of the laser beam can be measured.

The optical characteristic measurement device shown in FIG. 18 includes the collimator lens 102 for forming the divergent light beam emitted from the semiconductor laser beam emitting element 101 into the parallel beam, an objective lens 103 into which the beam emitted from the collimator lens 102 is made incident, a Charged Coupled Device (CCD) (image pick-up device) 121, an image processing device 122 for analyzing the detected result of the CCD 121, and a display device 123. According to this measurement device, the distribution of the light quantity of the laser beam can be measured.

The optical characteristic measurement device shown in FIG. 19 includes the collimator lens 102 for forming the divergent light beam emitted from the semiconductor laser beam emitting element 101 into the parallel beam, a position sensing element 131 of a photoelectric conversion type for detecting the light beam emitted from the collimator lens 102, a photoelectric conversion device 132 for converting the detected result of the position sensing element 131 into an electric signal, and a display device 133. According to this measurement device, the center of gravity of the distribution of the light quantity of the laser beam can be measured.

The optical characteristic measurement device shown in FIG. 20 includes the collimator lens 102 for forming the divergent light beam emitted from the semiconductor laser beam emitting element 101 into the parallel beam, an interferometer 140 and a display device 141. According to this measurement device, the aberration and other characteristics can be measured.

For recent miniaturized optical products, the arrangement of optical characteristic measurement devices for each of the optical axis, parallelism and intensity distribution of the laser beam has become difficult due to the spatial restriction. Also, the respective optical axis, parallelism and intensity distribution are designed with the relationship of trade off, and therefore an optical characteristic measurement device has been required, which is at low cost and can measure a plurality of characteristics at the time of assembling and adjusting.

However, the conventional optical characteristic measurement device can not measure both the incident optical axis and the intensity distribution of the laser beam simultaneously. As a result, there does not exist a measurement device which can simultaneously measure three elements of the optical axis, parallelism and intensity distribution of the laser beam.

The respective measurement devices shown in FIGS. 17 and 18 are generally provided with a CRT as the display device. Therefore, in order to read numerically the optical axis and the center of gravity of the intensity distribution from the displayed data, an operator has to read them from the display screen. Accordingly, reading errors by the operator frequently happen.

In the measurement device shown in FIG. 19, when the distribution of the light intensity of the laser beam having the straight-going property which passes through an aperture is evaluated at the aperture position, the measurement error occurs at the center of gravity of the intensity distribution in accordance with the relationship between the slight axial deviation of the incident light beam with respect to a sensor and the distance between the aperture and a light receiving surface of a position sensor.

In the measurement device shown in FIG. 20, the intensity distribution can be numerically evaluated but a long time is needed for the measurement and data processing. Therefore, many optical characteristic measurement devices are required for the application in the manufacturing process and thus a great cost of equipment is necessary.

Furthermore, every conventional optical characteristic measurement device is expensive and not economical. Particularly, the device shown in FIG. 20 is a newly-developed equipment and a lot of facilities are required.

### SUMMARY OF THE INVENTION

In view of the problems described above, it is advantage of the present invention to provide an optical characteristic measurement device for measuring optical characteristics of an incident laser beam, which is capable of performing various kinds of measurement with a simple optical system and to provide an optical type displacement meter to which the principles for measuring optical characteristics of an incident laser beam are applied.

In order to achieve the above advantage, according to the present invention, there is provided a measurement device including an optical path separation element to which a parallel laser beam is made incident through an aperture, a first face-type photo-detector for receiving the laser beam transmitted through the optical path separation element, and a second face-type photo-detector for receiving the laser beam reflected by the optical path separation element. Further, the measurement device is constituted in such a manner that the length of the optical path from the aperture to the first face-type photo-detector is set to be different from the length of the optical path from the aperture to the second face-type photo-detector.

According to the measurement device having such a constitution, the incident angle of the laser beam and the position of the center of gravity of the distribution of the light quantity at the aperture can be measured on the basis of the distance from a reference position to the light receiving center position on the first face-type photo-detector, the distance from the reference position to the light receiving center position on the second face-type photo-detector, the length of the optical path from the aperture to the first face-type photo-detector, and the length of the optical path from the aperture to the second face-type photo-detector.

In accordance with an embodiment of the present invention, the measurement device is preferably provided with an optical path synthesis element arranged either at a position on the optical path from the optical path separation element to the first face-type photo-detector or at a position on the optical path from the optical path separation element to the second face-type photo-detector, a light source for correction for emitting a parallel light for correction to the optical path separation element through the optical path synthesis element, and a reflection surface for correction for reflecting the parallel light for correction emitted from the optical path separation element to the optical path separation element and making the first face-type photo-detector and the second face-type photo-detector receive the return light. According to the embodiment constituted above, the positions or the like of the respective optical elements can be easily corrected with a high degree of precision.

In accordance with an embodiment of the present invention, the measurement device is preferably provided with an interferometer for detecting the laser beam entering the optical path separation element. According to the measurement device having such a constitution, the parallelism of the laser beam can be measured.

In accordance with an embodiment of the present invention, both the first face-type photo-detector and the second face-type photo-detector may be a position sensing element of a photoelectric conversion type such as a position detecting photodiode or a Position Sensitive Detector (PSD). Either the first face-type photo-detector or the second face-type photo-detector may be a position sensing element of a photoelectric conversion type and the other may be an image pick-up device, i.e., a Charge Coupled Device (CCD). Further, both the first face-type photo-detector and the second face-type photo-detector may be an image pick-up device.

The optical system in accordance with the present invention can be applied to an optical type displacement meter. In accordance with an embodiment of the present invention, there is provided an optical type displacement meter including a displacement measuring light source for emitting a parallel light beam for displacement measurement, an optical path separation element to which the parallel light beam emitted from the displacement measuring light source enters, a reflection face for reflecting the parallel light beam which is transmitted through or reflected by the optical path separation element to the optical path separation element, and a face-type photo-detector for receiving the return light from the reflection face which is reflected by or transmitted through the optical path separation element. The optical type displacement meter is constituted in such a manner that the reflection face is displaced with an inclined state at a prescribed angle with respect to the optical axis of the optical path separation element so that the displacement amount of the reflection face is measured on the basis of the inclined angle of the reflection face and the moving amount of the light receiving positions on the face-type photo-detector before and after its displacement.

According to the optical type displacement meter having such a constitution, the configuration as the optical characteristic measurement device can be utilized as the displacement meter, and thus the displacement meter can be simplified.

In accordance with another embodiment of the present invention, the measurement device further includes a converging lens to which the parallel laser beam is made incident and an image pick-up device which is arranged near the focal position of the converging lens.

According to the measurement device having such a constitution, the incident angle of the laser beam to the converging lens can be measured on the basis of the distance from the reference position to the light receiving center position in the image pick-up device and the length of the optical path from the converging lens to the face-type photo-detector.

Preferably, the measurement device is provided with an interferometer for detecting the incident light to the converging lens. According to the measurement device having such a constitution, the parallelism of the incident light can be measured.

In accordance with a further embodiment of the present invention, the measurement device further includes an optical path separation element to which a parallel laser beam is made incident through an aperture, a first face-type photo-detector for receiving the laser beam which is transmitted through or reflected by the optical path separation element, a second face-type photo-detector for receiving the laser beam which is reflected by or transmitted through the optical path separation element, and a converging lens arranged on the optical path from the optical path separation element to the second face-type photo-detector. The second face-type photo-detector is arranged near the focal position of the converging lens.

According to the measurement device having a such a constitution, the incident angle of the parallel light beam to the optical path separation element can be measured on the basis of the distance from the reference position to the light receiving center position on the second face-type photo-detector and the length of the optical path from the converging lens to the second face-type photo-detector. Further, the position of the center of gravity of the distribution of the light quantity at the aperture can be measured on the basis of the incident angle, the distance from the reference position to the light receiving center position on the first face-type photo-detector, and the length of the optical path from the aperture to the first face-type photo-detector.

Preferably, the measurement device is provided with an interferometer for detecting the incident light to the optical path separation element. According to the measurement device having such a constitution, the parallelism of the incident light can be measured.

In accordance with the embodiment of the present invention, both the first face-type photo-detector and the second face-type photo-detector may be a position sensing element of a photoelectric conversion type. Either the first face-type photo-detector or the second face-type photo-detector may be a position sensing element of a photoelectric conversion type and the other may be an image pick-up device. Further, both the first face-type photo-detector and the second face-type photo-detector may be an image pick-up device.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1 is a schematic block diagram of an entire optical characteristic measurement device 1A in accordance with a first embodiment of the present invention.

FIG. 2 is a plan view showing respective optical elements of the optical characteristic measurement device shown in FIG. 1.

FIG. 3 is a plan view showing a measurement principle in the optical characteristic measurement device shown in FIG. 1.

FIG. 4 is a developed explanatory view showing the respective optical elements positioned on a common optical path which are used in the optical characteristic measurement device shown in FIG. 1.

FIG. 5(A) is an explanatory plan view showing an essential portion of an optical characteristic measurement device 1B in accordance with a second embodiment of the present invention. FIG. 5(B) is a schematic plan view in which the optical characteristic measurement device 1B shown in FIG. 5(A) is used as a displacement meter, and FIG. 5(C) is an explanatory view showing the principle as the displacement meter.

FIG. 6 is an explanatory plan view showing an essential portion of an optical characteristic measurement device 1C in accordance with a third embodiment of the present invention.

FIG. 7(A) is an explanatory plan view showing an essential portion of an optical characteristic measurement device 1D in accordance with a fourth embodiment of the present invention and FIG. 7(B) is an explanatory view showing a detection result in a CCD (imaging sensor element) used as a first face-type photo-detector in the optical characteristic measurement device 1C shown in FIG. 7(A).

FIG. 8(A) is an explanatory plan view showing an essential portion of an optical characteristic measurement device 1E in accordance with a fifth embodiment of the present invention and FIG. 8(B) is an explanatory view showing a detection result in a CCD used as a second face-type photo-detector in the optical characteristic measurement device 1E shown in FIG. 8(A).

FIG. 9(A) is an explanatory plan view showing an essential portion of an optical characteristic measurement device 1F in accordance with a sixth embodiment of the present invention and FIG. 9(B) is an explanatory view showing detection results in CCDs used as face-type photo-detectors in the optical characteristic measurement device 1F shown in FIG. 9(A).

FIG. 10(A) is an explanatory plan view showing respective optical elements in an optical characteristic measurement device 1G in accordance with a seventh embodiment of the present invention and FIG. 10(B) is an explanatory plan view showing the respective optical elements which have a measurement function of the position of an optical axis in the optical characteristic measurement device 1G shown in FIG. 10(A).

FIG. 11 is an explanatory plan view showing a measurement principle in the optical characteristic measurement device 1G shown in FIG. 10(B).

FIG. 12 is a developed explanatory view showing the respective optical elements positioned on a common optical path which are used in the optical characteristic measurement device 1G shown in FIG. 10(B).

FIG. 13(A) is an explanatory plan view showing an essential portion of an optical characteristic measurement device 1H in accordance with an eighth embodiment of the present invention and FIG. 13(B) is an explanatory plan view showing an essential portion of another optical characteristic measurement device in this embodiment.

FIG. 14(A) is an explanatory plan view showing an essential portion of an optical characteristic measurement device 1I in accordance with a ninth embodiment of the present invention and FIG. 14(B) is an explanatory view showing a detection result in a CCD used as a first face-type photo-detector in the optical characteristic measurement device 1I shown in FIG. 14(A).

FIG. 15 is an explanatory plan view showing an essential portion of an optical characteristic measurement device 1J in accordance with a tenth embodiment of the present invention.

FIG. 16(A) is an explanatory plan view showing an essential portion of an optical characteristic measurement device 1K in accordance with an eleventh embodiment of the present invention and FIG. 16(B) is an explanatory view showing detection results in CCDs used as face-type photo-detectors in the optical characteristic measurement device 1K shown in FIG. 16(A).

FIG. 17 is an explanatory view showing an essential portion of a first conventional optical characteristic measurement device.

FIG. 18 is an explanatory view showing an essential portion of a second conventional optical characteristic measurement device.

FIG. 19 is an explanatory view showing an essential portion of a third conventional optical characteristic measurement device.

FIG. 20 is an explanatory view showing an essential portion of a fourth conventional optical characteristic measurement device.

### DETAILED DESCRIPTION OF THE PREFERRED EMBODIMENTS

Optical characteristic measurement devices and an optical type displacement meter in accordance with embodiments of the present invention will be described below with reference to the accompanying drawings.

### Embodiment 1

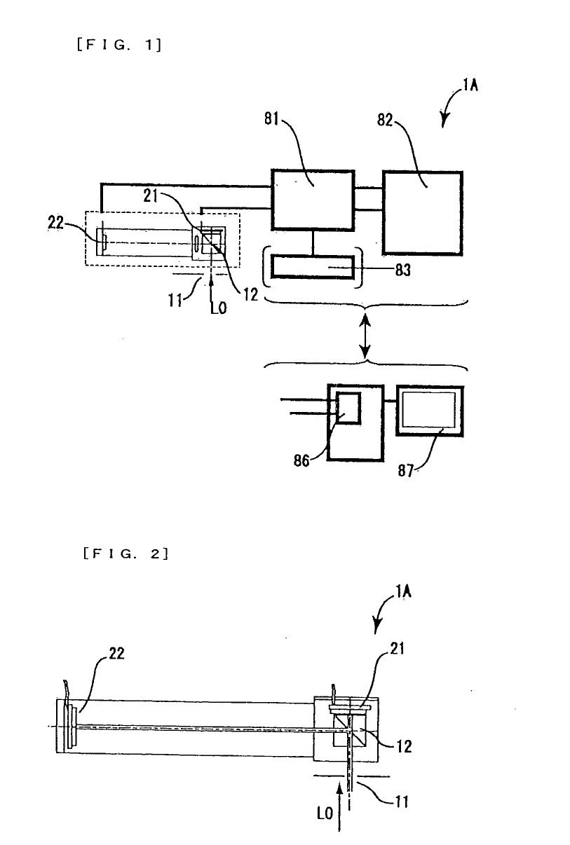

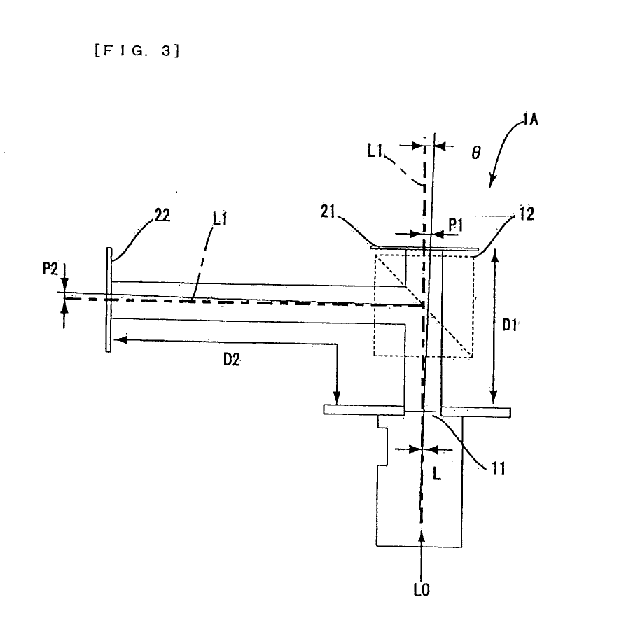

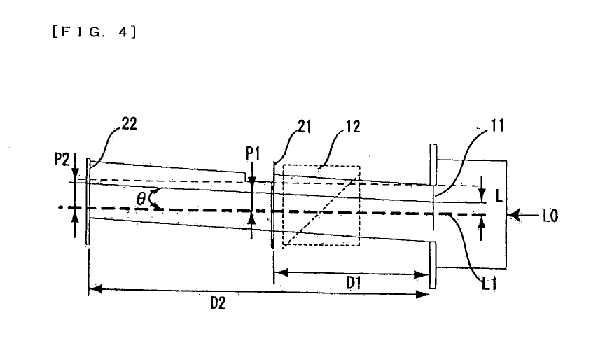

FIG. 1 is a schematic block diagram of an entire optical characteristic measurement device 1A to which the present invention is applied and FIG. 2 is an explanatory plan view showing respective optical elements in the optical characteristic measurement device 1A shown in FIG. 1. FIG. 3 is an explanatory plan view showing a measurement principle in the optical characteristic measurement device 1A shown in FIG. 1 and FIG. 4 is a developed explanatory view showing the respective optical elements positioned on a common optical path which are used in the optical characteristic measurement device 1A shown in FIG. 1.

As shown in FIGS. 1 and 2, an optical characteristic measurement device 1A in accordance with this embodiment includes an aperture 11 to which a laser beam L0 emitted from a semiconductor laser light emitting element (not shown) is made incident in a parallel form by a collimator lens (not shown), a beam splitter (optical path separation element) 12 formed of a prism, which is arranged on the course of the emitted light beam from the aperture 11, a first position sensing element 21 (first face-type photo-detector) of a photoelectric conversion type which receives the light transmitted through a semi-transmitting reflection film of the beam splitter 12, and a second position sensing element 22 (second face-type photo-detector) of a photoelectric conversion type which receives the light reflected by the semi-transmitting reflection film of the beam splitter 12. The detection results in the first position sensing element 21 and the second position sensing element 22 are outputted to a data storage section 82 through a signal processing circuit 81 and the measurement result is displayed with a display device 83. A personal computer 87 may be used as the signal processing circuit and display device through an A/D converter 86.

In the optical characteristic measurement device 1A constituted above, the laser beam L0 emitted from the semiconductor laser light emitting element is, as shown in FIG. 3, narrowed down by the aperture 11 into a prescribed width of the light beam. One portion of the laser beam L0 is transmitted to the semi-transmitting reflection film of the beam splitter 12 to be detected by the first position sensing element 21 and the other portion is reflected by the semi-transmitting reflection film of the beam splitter 12 to be detected by the second position sensing element 22.

FIG. 4 shows the respective optical elements developed on a common optical path. In the optical characteristic measurement device 1A of this embodiment, when the inclination of the optical axis of the laser beam L0 (incident angle) with respect to the virtual reference line L1 (alternating long and short dash lines) determined mechanically is set to be “θ”, the position of the center of gravity in the distribution of the quantity of light at the aperture 11 viewed from the virtual reference line L1 is set to be “L”, the deviation amounts of the first position sensing element 21 and the second position sensing element 22 from the virtual reference line L1 are respectively set to be P1 and P2, the distance from the aperture 11 to the first position sensing element 21 through the transmission of the semi-transmitting reflection film of the beam splitter 12 is set to be “D1”, and the distance from the aperture 11 to the second position sensing element 22 via the reflection of the semi-transmitting reflection film of the beam splitter 12 is set to be “D2” (D1≠D2), the incident angle θ and the position L of the center of gravity in the distribution of the light quantity are obtained by the following expressions.

θ=arc tan {(P2−P1)/(D2−D1)} (1)

L=P1−D1*tan θ (2)

Accordingly, the optical axis of the laser beam L0 can be obtained by using two position sensing elements 21, 22 and one beam splitter 12, and the position of the center of gravity of the distribution of the quantity of light can be obtained on the basis of the detection result of the position sensing element 21.

### Embodiment 2

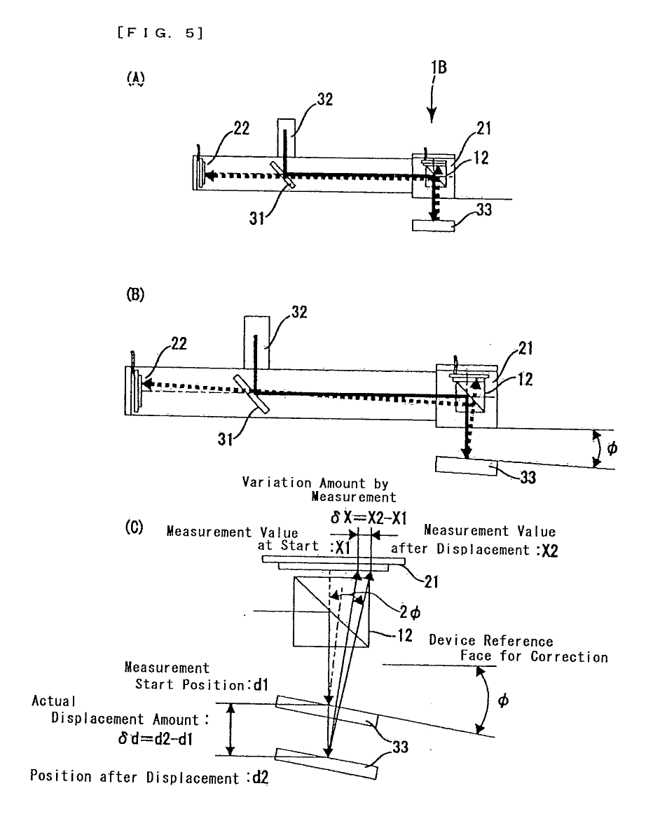

FIG. 5(A) is an explanatory plan view showing an essential portion of an optical characteristic measurement device 1B in accordance with a second embodiment of the present invention. FIG. 5(B) is a schematic plan view in which the device shown in FIG. 5(A) is used as a displacement meter. FIG. 5(C) is an explanatory view showing a principle as the displacement meter. Respective embodiments described below have the basic configuration similar to the first embodiment, and thus the same notational symbols are referred to the common functional portions and their detailed explanations are omitted.

In the first embodiment, the respective angles and zero positions in data processing (reference position) of the position sensing elements 21 and 22 are set on the basis of the virtual reference line L1 which is mechanically determined on the device. However, the second embodiment is constituted in such a manner that the angles and zero positions in data processing of the position sensing elements 21 and 22 can be optically corrected.

That is, similarly as the first embodiment, the measurement device 1B of this embodiment includes, as shown in FIG. 5(A), the beam splitter 12 formed of a prism to which the laser beam L0 emitted from the semiconductor laser light emitting element (not shown) is made incident through a collimator lens and the aperture (both are not shown), the first position sensing element 21 (first face-type photo-detector) of a photoelectric conversion type which receives the light transmitted through the semi-transmitting reflection film of the beam splitter 12, and the second position sensing element 22 (second face-type photo-detector) of a photoelectric conversion type which receives the light reflected by the semi-transmitting reflection film of the beam splitter 12.

Also, this embodiment is constituted in such a manner that a half mirror 31 (optical path synthesis element) is arranged on the optical path from the beam splitter 12 to the second position sensing element 22 and a parallel light is emitted from a reference light source 32 toward the half mirror 31. Also, a reference reflective surface 33 is capable of being disposed at the position of the aperture 11.

The light beam emitted from the reference light source 32 is reflected by the half mirror 31 and then reflected by the beam splitter 12 to advance to the reference reflective surface 33. One portion of the reflected light beam by the reference reflective surface 33 is transmitted to the semi-transmitting reflection film of the beam splitter 12 to be detected by the first position sensing element 21 and the other portion is reflected by the semi-transmitting reflection film of the beam splitter 12 and is transmitted to the half mirror 31 to be detected by the second position sensing element 22.

The reference light source 32, the half mirror 31 and the reference reflective surface 33 are arranged in such a manner that the angles and zero positions in data processing of the first position sensing element 21 and the second position sensing element 22 can be adjusted on the basis of the detection results (sensor output) of the first position sensing element 21 and the second position sensing element 22. Accordingly, the angles and zero positions in data processing of the first position sensing element 21 and the second position sensing element 22 can be accurately corrected according to the detection results (sensor output) of the first position sensing element 21 and the second position sensing element 22.

The optical characteristic measurement device 1B shown in FIG. 5(A) can be constituted as an optical type displacement meter as shown in FIG. 5(B) by utilizing the correction principle. In this optical type displacement meter, the reference reflective surface 33 is disposed so as to be inclined slightly with an angle φ with respect to the reference horizontal plane. Further, the reference reflective surface 33 is movable in the optical axis direction together with a displacement of an amount of work (not shown) which is an object to be measured for the displacement meter. Therefore, as shown in FIG. 5(C), when the reference reflective surface 33 is displaced from the start position d1 to the displaced position d2 in the optical axis direction by the movement of the displacement of an amount of work and thus the measured value of the position sensing element 21 is varied from the start measured value X1 to the displaced measured value X2, the displacement amount δd=(d2−d1) of the displacement of an amount of work is obtained by the following expression on the basis of the variation δX=(X2−X1) of the measured value.

δd=δX/(tan(2φ)) (3)

### Embodiment 3

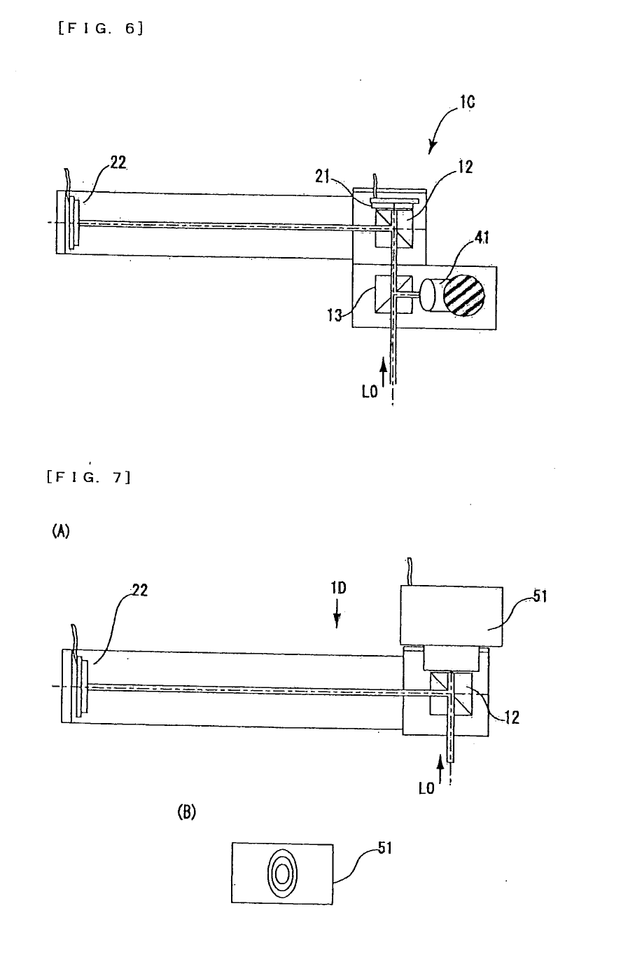

FIG. 6 is an explanatory view which shows an essential portion of an optical characteristic measurement device 1C in accordance with the third embodiment of the present invention.

As shown in FIG. 6, similarly as the first embodiment, this embodiment includes the beam splitter 12 formed of a prism to which the laser beam L0 emitted from the semiconductor laser light emitting element (not shown) is made incident through a collimator lens and the aperture (both are not shown), the first position sensing element 21 (first face-type photo-detector) of a photoelectric conversion type which receives the light transmitted through the semi-transmitting reflection film of the beam splitter 12, and the second position sensing element 22 (second face-type photo-detector) of a photoelectric conversion type which receives the light reflected by the semi-transmitting reflection film of the beam splitter 12.

In this embodiment, a beam splitter 13 is arranged on the optical path from the semiconductor laser light emitting element to the beam splitter 12 and the light beam transmitted through the semi-transmitting reflection film of the beam splitter 13 is advanced toward the beam splitter 12. Also, the light beam reflected by the semi-transmitting reflection film of the beam splitter 13 enters a portable interferometer 41. Other constitution is generally similar to the first embodiment.

Therefore, according to the optical characteristic measurement device 1C in accordance with this embodiment, as described in the first embodiment, the optical axis of the laser beam L0 can be obtained by the two position sensing elements 21, 22 and the beam splitter 12, and further, the position of the center of gravity of the distribution of the light quantity can be obtained on the basis of the detection result of the position sensing element 21. Also, the parallelism of the laser beam L0 can be measured by using the beam splitter 13 and the portable interferometer 41.

### Embodiment 4

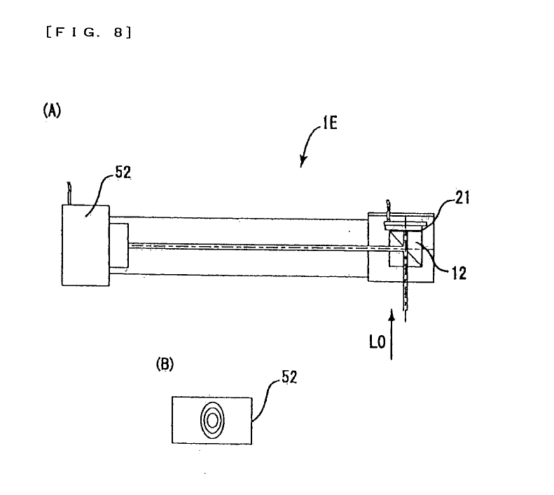

FIG. 7(A) is an explanatory plan view showing an essential portion of an optical characteristic measurement device 1D in accordance with a fourth embodiment of the present invention and FIG. 7(B) is an explanatory view showing a detection result in a CCD (image pick-up sensor element) used as a first face-type photo-detector in the optical characteristic measurement device 1D shown in FIG. 7(A).

As shown in FIG. 7(A), similarly as the first embodiment, this embodiment includes the beam splitter 12 formed of a prism to which the laser beam L0 emitted from the semiconductor laser light emitting element (not shown) is made incident through a collimator lens and the aperture (both are not shown), a first face-type photo-detector which receives the light transmitted through the semi-transmitting reflection film of the beam splitter 12, and the position sensing element 22 (second face-type photo-detector) which receives the light reflected by the semi-transmitting reflection film of the beam splitter 12. In the first embodiment, the position sensing element is used as the first face-type photo-detector, however, a CCD 51 is used in this embodiment.

In the optical characteristic measurement device 1D constituted above, the CCD 51 used as the first face-type photo-detector obtains the data as shown in FIG. 7(B). Therefore, similar to the first embodiment, the optical axis of the laser beam L0 and the position of the center of gravity of the distribution of the light quantity can be obtained.

### Embodiment 5

FIG. 8(A) is an explanatory plan view showing an essential portion of an optical characteristic measurement device 1E in accordance with a fifth embodiment of the present invention and FIG. 8(B) is an explanatory view showing a detection result in a CCD used as a second face-type photo-detector in the optical characteristic measurement device 1E shown in FIG. 8(A).

As shown in FIG. 8(A), similarly as the first embodiment, this embodiment includes the beam splitter 12 formed of a prism to which the laser beam L0 emitted from the semiconductor laser light emitting element (not shown) is made incident through a collimator lens and the aperture (both are not shown), the position sensing element 21 (first face-type photo-detector) which receives the light transmitted through the semi-transmitting reflection film of the beam splitter 12, and the second face-type photo-detector which receives the light reflected by the semi-transmitting reflection film of the beam splitter 12. In the first embodiment, the position sensing element is used as the second face-type photo-detector, however, a CCD 52 is used in this embodiment.

Also, in the optical characteristic measurement device 1E constituted above, the CCD 52 used as the second face-type photo-detector obtains the data as shown in FIG. 8(B). Therefore, as similar to the first embodiment, the optical axis of the laser beam L0 and the position of the center of gravity of the distribution of the light quantity can be obtained.

### Embodiment 6

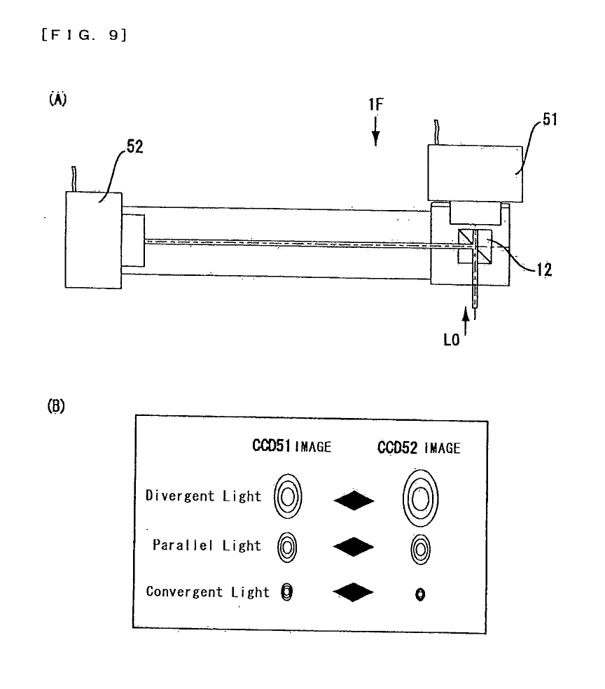

FIG. 9(A) is an explanatory plan view showing an essential portion of an optical characteristic measurement device 1F in accordance with a sixth embodiment of the present invention and FIG. 9(B) is an explanatory view showing detection results in CCDs used as face-type photo-detectors in the optical characteristic measurement device 1F shown in FIG. 9(A).

As shown in FIG. 9(A), similarly as the first embodiment, this embodiment includes the beam splitter 12 formed of a prism to which the laser beam L0 emitted from the semiconductor laser light emitting element (not shown) is made incident through a collimator lens and the aperture (both are not shown), the first face-type photo-detector which receives the light transmitted through the semi-transmitting reflection film of the beam splitter 12, and the second face-type photo-detector which receives the light reflected by the semi-transmitting reflection film of the beam splitter 12. In the first embodiment, the position sensing elements are used as the first and the second face-type photo-detectors, but in this embodiment, the first CCD 51 is used as the first face type photo-detector and the second CCD 52 is used as the second face type photo-detector.

Also in the optical characteristic measurement device 1F constituted above, the CCDs 51, 52 used as the face-type photo-detectors obtain the data as shown in FIG. 9(B). Therefore, as similar to the first embodiment, the optical axis of the laser beam L0 and the position of the center of gravity of the distribution of the light quantity can be obtained.

The detection results of the first CCD 51 and the second CCD 52 are shown in FIG. 9(B), which show different image data in accordance with a divergent light, parallel light or convergent light. Therefore, the detection results of the first CCD 51 and the second CCD 52 are compared, for example, to obtain their ratios so that the parallelism of the incident light can be measured and evaluated.

### Embodiment 7

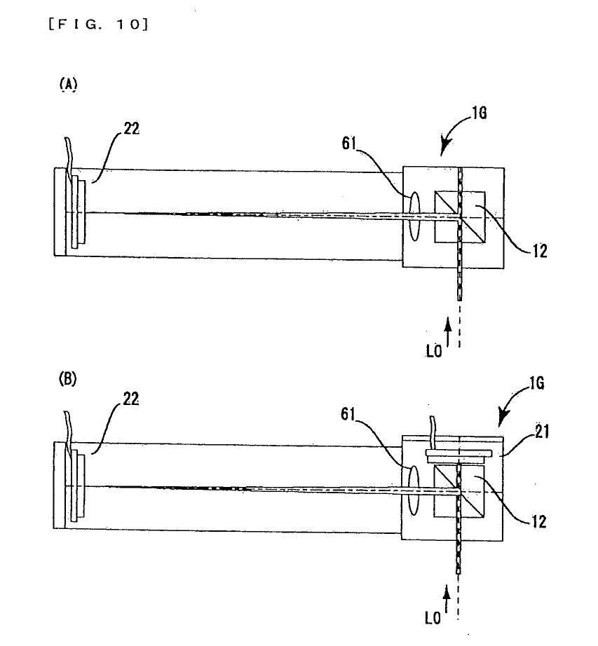

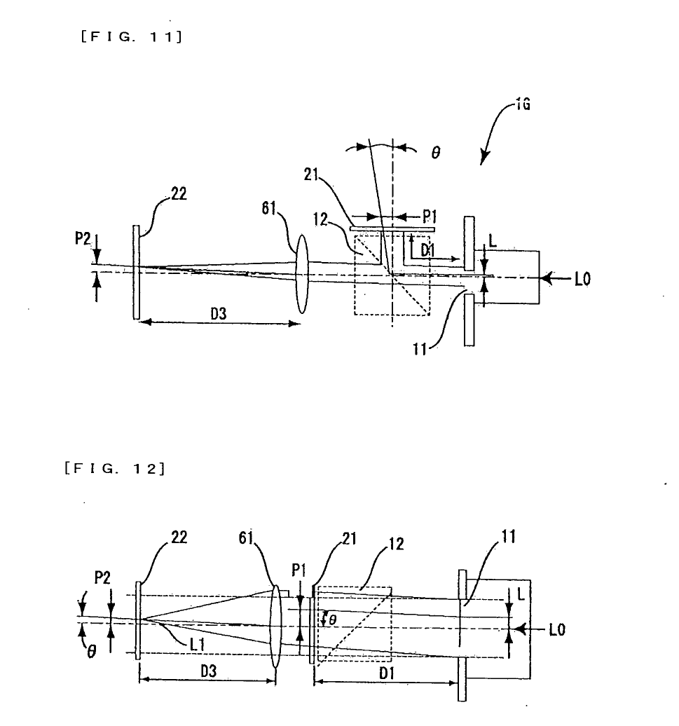

FIG. 10(A) is an explanatory plan view showing respective optical elements in an optical characteristic measurement device 1G in accordance with a seventh embodiment of the present invention. FIG. 10(B) is an explanatory plan view showing the respective optical elements which has a measurement function of an optical axis position in the optical characteristic measurement device 1G shown in FIG. 10(A). FIG. 11 is an explanatory plan view showing a measurement principle in the optical characteristic measurement device shown in FIG. 10(B). FIG. 12 is a developed explanatory view showing the respective optical elements positioned on a common optical path which are used in the optical characteristic measurement device shown in FIG. 10(B).

As shown in FIG. 10(A), the measurement device 1G of this embodiment includes the beam splitter 12 formed of a prism to which the laser beam L0 emitted from the semiconductor laser light emitting element (not shown) is made incident through a collimator lens and the aperture (both are not shown), and the second position sensing element 22 (second face-type photo-detector) which receives the light reflected by the semi-transmitting reflection film of the beam splitter 12. Also, in the optical characteristic measurement device 1G of this embodiment, a converging lens 61 is arranged at a position on the optical path from the beam splitter 12 and the second position sensing element 22. The second position sensing element 22 is arranged near the focal point position of the convergent lens 61.

In the optical characteristic measurement device 1G constituted above, the optical axis of the incident light beam (incident angle) can be obtained on the basis of the detection result of the second position sensing element 22 as described below.

In the optical characteristic measurement device 1G shown in FIG. 10(B), the optical axis of the laser beam L0 and the position of the center of gravity of the distribution of the light quantity can be obtained by providing the position sensing element 21 (first face-type photo-detector) which receives the light transmitted through the semi-transmitting reflection film of the beam splitter 12.

In the optical characteristic measurement device 1G constituted above, the laser beam L0 emitted from the semiconductor laser light emitting element is, as shown in FIG. 11, narrowed to a prescribed light beam by the aperture 11, and then one portion of the laser beam L0 is transmitted through the semi-transmitting reflection film of the beam splitter 12 to be detected by the first position sensing element 21, and the other portion is reflected with the semi-transmitting reflection film of the beam splitter 12 and turned into a convergent light by means of the converging lens 61 to be detected by the second position sensing element 22.

FIG. 12 illustrates the respective optical elements developed on a common optical path. Accordingly, in the optical characteristic measurement device 1G of this embodiment, when the inclination of the optical axis of the laser beam L0 (incident angle) with respect to the virtual reference line L1 (alternating long and short dash lines) is set to be “θ”, the deviation amount on the second position sensing element 22 from the reference position is set to be P2, and the distance from the converging lens 61 to the second position sensing element 22 is set to be “D3”, the incident angle θ is obtained by the following expression.

θ=arc tan {P2/D3} (4)

In addition, when the incident angle θ is obtained, the position L of the center of gravity of the distribution of the quantity of light at the aperture 11 can be obtained by using the following expression on the basis of the deviation amount P1 on the first position sensing element 21 and the distance D1 from the aperture 11 to the first position sensing element 21 through the semi-transmitting reflection film of the beam splitter 12.

L=P1−D1*tan θ (5)

Accordingly, the optical axis (incident angle) of the laser beam L0 can be obtained with one position sensing element 22 and one convergent lens 61, and further, the position of the center of gravity of the distribution of the quantity of light can be obtained on the basis of this incident angle and the detection result of one position sensing element 21.

### Embodiment 8

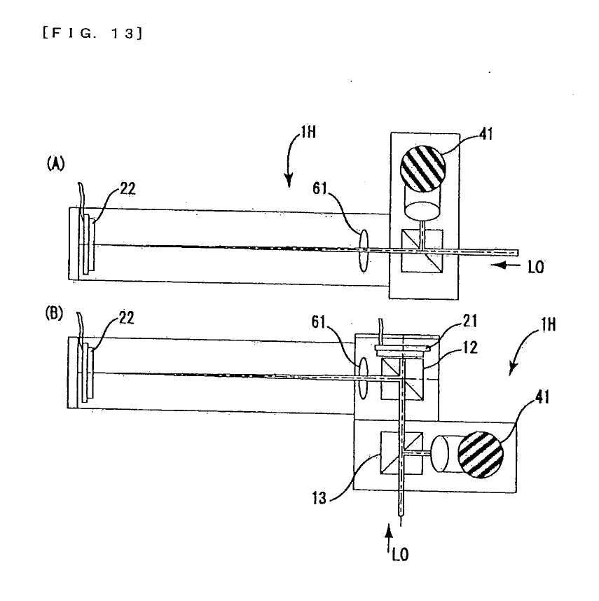

FIG. 13(A) is an explanatory plan view showing an essential portion of an optical characteristic measurement device 1H in accordance with an eighth embodiment of the present invention and FIG. 13(B) is an explanatory plan view showing an essential portion of another optical characteristic measurement device in this embodiment.

The optical characteristic measurement device 1H shown in FIG. 13(A) is a modified example of the measurement device 1G shown in FIG. 10(A). The optical characteristic measurement device 1H includes the beam splitter 12 to which the laser beam L0 emitted from the semiconductor laser light emitting element (not shown) is made incident through a collimator lens and the aperture (both are not shown), and the second position sensing element 22 (second face-type photo-detector) which receives the light transmitted through the semi-transmitting reflection film of the beam splitter 12. Also, in the optical characteristic measurement device 1H of this embodiment, the convergent lens 61 is arranged at a position on the optical path from the beam splitter 12 and the second position sensing element 22. The second position sensing element 22 is arranged near the focal point position of the convergent lens 61.

When the portable interferometer 41 is further provided with the optical characteristic measurement device 1H constituted above as the third embodiment, it is preferable to arrange the portable interferometer 41 at a position for receiving the reflected light beam from the beam splitter 12. As constituted above, the light beam reflected by the semi-transmitting reflection film of the beam splitter 12 enters the portable interferometer 41, and thus the parallelism of the light beam can be measured.

On the other hand, from the constitution of the device shown in FIG. 10(B), the beam splitter 13 may be preferably arranged on the optical path from the semiconductor laser light emitting element to the beam splitter 12 and the portable interferometer 41 detects the light beam reflected with the semi-transmitting reflection film of the beam splitter 13 as shown in FIG. 13(B).

According to such a constitution described above, a function for measuring the parallelism of the light beam can be provided in the optical characteristic measurement device 1H in accordance with the seventh embodiment.

### Embodiment 9

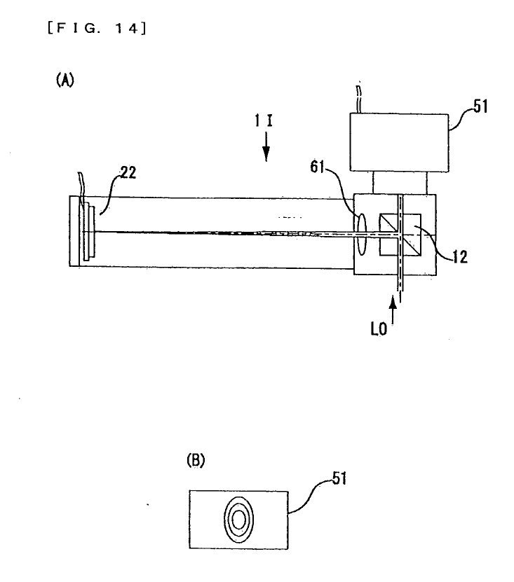

FIG. 14(A) is an explanatory plan view showing an essential portion of an optical characteristic measurement device 1I in accordance with a ninth embodiment of the present invention and FIG. 14(B) is an explanatory view showing a detection result in a CCD used as a first face-type photo-detector in the optical characteristic measurement device 1I shown in FIG. 14(A).

As shown in FIG. 14(A), similar to the seventh embodiment, this embodiment includes the beam splitter 12 formed of a prism to which the laser beam emitted from the semiconductor laser light emitting element (not shown) is made incident through the collimator lens and the aperture (both are not shown), the first face-type photo-detector which receives the light transmitted through the semi-transmitting reflection film of the beam splitter 12, and the position sensing element 22 (second face-type photo-detector) which receives the light reflected by the semi-transmitting reflection film of the beam splitter 12. In the seventh embodiment, the first face-type photo-detector is used as the position sensing element, however, the CCD 51 is used in this embodiment.

Also in the optical characteristic measurement device 1I constituted above, the CCD 51 used as the first face-type photo-detector obtains the data shown in FIG. 14(B). Therefore, similar to the seventh embodiment, the optical axis of the laser beam L0 and the position of the center of gravity of the distribution of the light quantity can be obtained.

### Embodiment 10

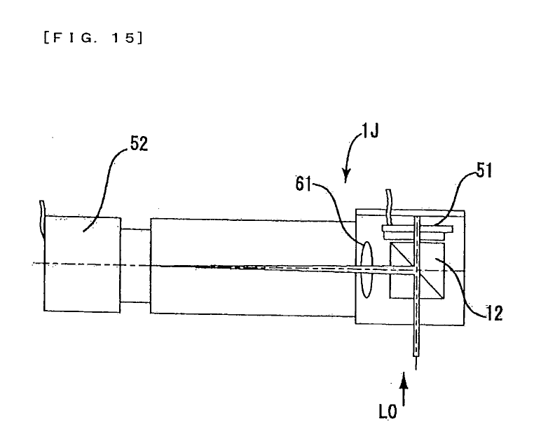

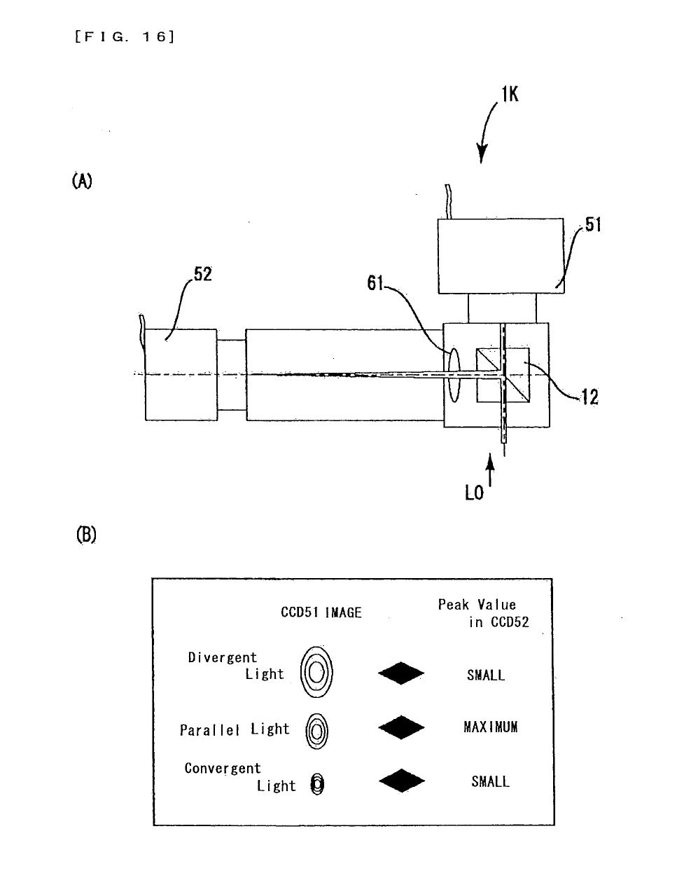

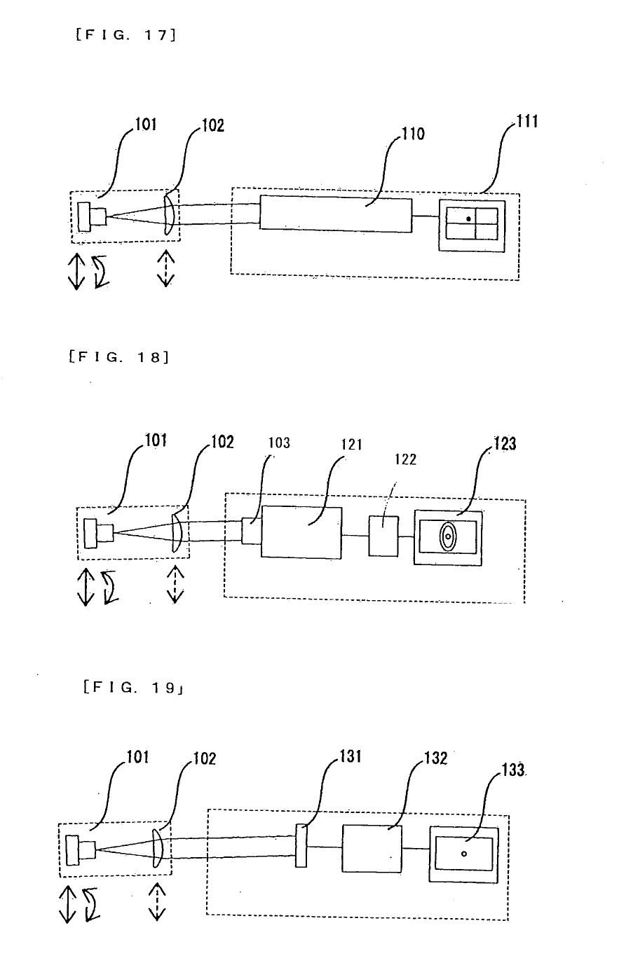

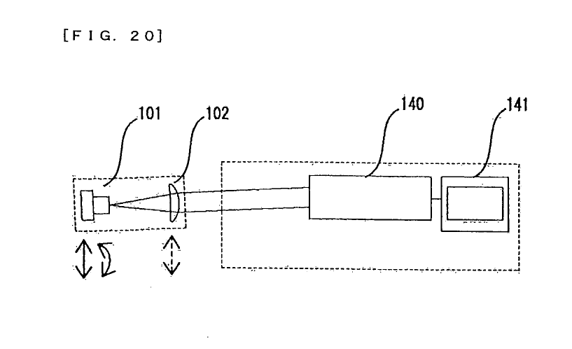

FIG. 15 is an explanatory plan view showing an essential portion of an optical characteristic measurement device 1J in accordance with a tenth embodiment of the present invention.

As shown in FIG. 15, similar to the seventh embodiment, this embodiment includes the beam splitter 12 formed of a prism to which the laser beam L0 emitted from the semiconductor laser light emitting element (not shown) is made incident through a collimator lens and the aperture (both are not shown), the position sensing element (first face-type photo-detector) which receives the light transmitted through the semi-transmitting reflection film of the beam splitter 12, and the second face-type photo-detector which receives the light reflected by the semi-transmitting reflection film of the beam splitter 12. In the seventh embodiment, the position sensing element is used as the second face-type photo-detector, however, the CCD 52 is used in this embodiment.

Also in the optical characteristic measurement device 1J constituted above, similar to the seventh embodiment, the optical axis of the laser beam L0 and the position of the center of gravity of the distribution of the light quantity can be obtained.

### Embodiment 11

FIG. 16(A) is an explanatory plan view showing an essential portion of an optical characteristic measurement device 1K in accordance with an eleventh embodiment of the present invention and FIG. 16(B) is an explanatory view showing detection results in CCDs used as face-type photo-detectors in the optical characteristic measurement device 1K shown in FIG. 16(A).

As shown in FIG. 16(A), similar to the seventh embodiment, this embodiment includes the beam splitter 12 formed of a prism to which the laser beam L0 emitted from the semiconductor laser light emitting element (not shown) is made incident through a collimator lens and the aperture (both are not shown), the first face-type photo-detector which receives the light transmitted through the semi-transmitting reflection film of the beam splitter 12, and the second face-type photo-detector which receives the light reflected by the semi-transmitting reflection film of the beam splitter 12. In the seventh embodiment, the position sensing elements are used as the first and the second face-type photo-detectors, but in this embodiment, the first CCD 51 is used as the first face type photo-detector and the second CCD 52 is used as the second face type photo-detector.

Also in the optical characteristic measurement device 1K constituted above, the CCDs 51 and 52 used as the face-type photo-detectors obtain the data shown in FIG. 16(B). Therefore, similar to the seventh embodiment, the optical axis of the laser beam L0 and the position of the center of gravity of the distribution of the light quantity can be obtained.

The detection result of the first CCD 51 becomes different image data in accordance with a divergence light, parallel light or convergence light of the laser beam. The detection result of the second CCD 52 becomes a different peak value of the beam spot in accordance with the divergence light, parallel light or convergence light. Therefore, the detection results of the first CCD 51 and the second CCD 52 are compared so that the parallelism of the incident light can be measured and evaluated.

As described above, the optical characteristic measurement device according to the present invention includes the optical path separation element to which the parallel laser beam is made incident through the aperture, the first face-type photo-detector for receiving the laser beam transmitted through the optical path separation element, and the second face-type photo-detector for receiving the laser beam reflected by the optical path separation element. Consequently, the incident angle of the laser beam and the position of the center of gravity of the distribution of the light quantity at the aperture can be measured on the basis of the distance from the reference position to the light receiving center position on the first face-type photo-detector, the distance from the reference position to the light receiving center position on the second face-type photo-detector, the length of the optical path from the aperture to the first face-type photo-detector, and the length of the optical path from the aperture to the second face-type photo-detector.

Also, the optical characteristic measurement device in accordance with another embodiment of the present invention includes an optical path separation element to which a parallel laser beam is made incident through an aperture, a first face-type photo-detector for receiving the laser beam which is transmitted through or reflected by the optical path separation element, a second face-type photo-detector for receiving the laser beam which is reflected by or transmitted through the optical path separation element, and a converging lens arranged on the optical path from the optical path separation element to the second face-type photo-detector. The second face-type photo-detector is arranged near the focal position of the converging lens. As a result, the incident angle of the paralleled light beam to the optical path separation element can be measured on the basis of the distance from the reference position to the light receiving center position on the second face-type photo-detector and the length of the optical path from the converging lens to the second face-type photo-detector. Further, the position of the center of gravity of distribution of the light quantity at the aperture can be measured on the basis of the incident angle, the distance from the reference position to the light receiving center position on the first face-type photo-detector, and the length of the optical paths from the aperture to the first face-type photo-detector.

Also, the optical type displacement meter according to the present invention includes the displacement measuring light source for emitting the parallel light beam for displacement measurement, the optical path separation element to which the parallel light beam emitted from the displacement measuring light source enters, the reflection face for reflecting the parallel light beam which is transmitted through or reflected by the optical path separation element to the optical path separation element, and the face-type photo-detector for receiving the return light from the reflection face which is reflected by or transmitted through the optical path separation element. The reflection face is displaced with an inclined state at a prescribed angle with respect to the optical axis of the optical path separation element so that the displacement amount of the reflection face is measured on the basis of the inclined angle of the reflection face and the moving amount of the light receiving positions on the face-type photo-detector before and after its displacement. Consequently, the configuration as the optical characteristic measurement device can be utilized as the displacement meter, and thus the displacement meter can be simplified.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical characteristic measurement device comprising:
an optical path separation element to which a parallel laser beam is made incident through an aperture;
a first face-type photo-detector that receives the laser beam transmitted through the optical path separation element; and
a second face-type photo-detector that receives the laser beam reflected by the optical path separation element,
wherein a length of an optical path from the aperture to the first face-type photo-detector is set to be different from a length of an optical path from the aperture to the second face-type photo-detector, and an incident angle of the laser beam and a position of a center of gravity of a distribution of a light quantity of the laser beam at the aperture are measured based on a distance from a reference position to a light receiving center position on the first face-type photo-detector, a distance from a reference position to a light receiving center position on the second face-type photo-detector, the length of the optical path from the aperture to the first face-type photo-detector, and the length of the optical path from the aperture to the second face-type photo-detector.

2. The optical characteristic measurement device according to claim 1, further comprising an interferometer that detects the laser beam which enters the optical path separation element.

3. The optical characteristic measurement device according to claim 1, wherein both the first face-type photo-detector and the second face-type photo-detector are a position sensing element of a photoelectric conversion type.

4. The optical characteristic measurement device according to claim 1, wherein one of the first face-type photo-detector and the second face-type photo-detector is a position sensing element of a photoelectric conversion type and the other is an image pick-up device.

5. The optical characteristic measurement device according to claim 1, wherein both of the first face-type photo-detector and the second face-type photo-detector are image pick-up devices.

6. The optical characteristic measurement device according to claim 1, further comprising:
an optical path synthesis element arranged either at a position on the optical path from the optical path separation element to the first face-type photo-detector or at a position on the optical path from the optical path separation element to the second face-type photo-detector;
a correction light source that emits a correction parallel light to the optical path separation element through the optical path synthesis element, and
a correction reflection face that reflects the parallel light from the optical path separation element to the optical path separation element to make the first face-type photo-detector and the second face-type photo-detector receive its return light.

7. The optical characteristic measurement device according to claim 6, further comprising an interferometer that detects the laser beam which enters the optical path separation element.

8. The optical characteristic measurement device according to claim 6, wherein both the first face-type photo-detector and the second face-type photo-detector are a position sensing element of a photoelectric conversion type.

9. The optical characteristic measurement device according to claim 6, wherein one of the first face-type photo-detector and the second face-type photo-detector is a position sensing element of a photoelectric conversion type and the other is an image pick-up device.

10. The optical characteristic measurement device according to claim 6, wherein both of the first face-type photo-detector and the second face-type photo-detector are image pick-up devices.

11. An optical characteristic measurement device comprising:
a convergent lens to which a parallel laser beam is made incident; and
an image pick-up device which is arranged near a focal position of the converging lens,
wherein an incident angle of the laser beam to the convergent lens is measured based on a distance from a reference position to a light receiving center position in the image pick-up device and a length of an optical path from the convergent lens to a face-type photo-detector.

12. The optical characteristic measurement device according to claim 11, further comprising an interferometer that detects the incident light to the converging lens.

13. An optical characteristic measurement device comprising:
an optical path separation element to which a parallel laser beam is made incident through an aperture;
a first face-type photo-detector that receives the laser beam which is transmitted through or reflected by the optical path separation element;
a second face-type photo-detector that receives the laser beam which is reflected by or transmitted through the optical path separation element; and
a convergent lens arranged on an optical path from the optical path separation element to the second face-type photo-detector,
wherein the second face-type photo-detector is arranged near a focal position of the converging lens, and
wherein an incident angle of the parallel light beam to the optical path separation element is measured based on a distance from a reference position to a light receiving center position on the second face-type photo-detector and a length of an optical path from the convergent lens to the second face-type photo-detector, and
a position of a center of gravity of distribution of a light quantity at the aperture is measured based on the incident angle, the distance from the reference position to the light receiving center position on the first face-type photo-detector, and the length of the optical paths from the aperture to the first face-type photo-detector.

14. The optical characteristic measurement device according to claim 13, further comprising an interferometer that detects the incident light to the optical path separation element.

15. The optical characteristic measurement device according to claim 13, wherein both the first face-type photo-detector and the second face-type photo-detector are a position sensing element of a photoelectric conversion type.

16. The optical characteristic measurement device according to claim 13, wherein one of the first face-type photo-detector and the second face-type photo-detector is a position sensing element of a photoelectric conversion type and the other is an image pick-up device.

17. The optical characteristic measurement device according to claim 13, wherein both of the first face-type photo-detector and the second face-type photo-detector are image pick-up devices.

18. An optical characteristic measurement device comprising:
an optical path separation element to which a parallel laser beam is made incident through an aperture;
a first face-type photo-detector that receives the laser beam transmitted through the optical path separation element; and
a second face-type photo-detector that receives the laser beam reflected by the optical path separation element,
wherein a length of an optical path from the aperture to the first face-type photo-detector is set to be different from a length of an optical path from the aperture to the second face-type photo-detector.

19. An optical type displacement meter comprising:
a displacement measuring light source that emits a parallel light beam for displacement measurement;
an optical path separation element to which the parallel light beam emitted from the displacement measuring light source enters;
a reflection face that reflects the parallel light beam which is transmitted through or reflected by the optical path separation element toward the optical path separation element; and
a face-type photo-detector that receives the return light from the reflection face which is reflected by or transmitted through the optical path separation element,
wherein the reflection face is displaced with an inclined state at a prescribed angle with respect to an optical axis of the optical path separation element so that a displacement amount of the reflection face is measured based on an inclined angle of the reflection face and a moving amount of light receiving positions on the face-type photo-detector before and after its displacement.

20. The optical characteristic measurement device according to claim 19, further comprising an interferometer that detects the laser beam which enters the optical path separation element.
